(19) United States
(12) Patent Application Publication
(10) Pub. No.: US 2018/0191600 A1
(43) Pub. Date: Jul. 5, 2018

(54) REDIRECTION OF SERVICE OR DEVICE DISCOVERY MESSAGES IN SOFTWARE-DEFINED NETWORKS

(71) Applicant: Huawei Technologies Co., Ltd., Shenzhen (CN)

(72) Inventors: Artur Hecker, Munich (DE); Ishan Vaishnavi, Munich (DE)

(21) Appl. No.: 15/906,167

(22) Filed: Feb. 27, 2018

Related U.S. Application Data
(63) Continuation of application No. PCT/EP2015/069817, filed on Aug. 31, 2015.

(51) Int. Cl. H04L 12/751; H04L 12/24

(52) U.S. Cl. CPC H04L 45/02; H04L 41/5058; H04L 41/12

(57) ABSTRACT

A method and apparatus for redirecting service or device discovery (SD) messages in a software-defined network (SDN) is provided. The SDN comprises a plurality of network nodes, one or more SD serving nodes, and a server. The one or more network nodes of the plurality of network nodes are instructed by the server to redirect received broadcast or multicast SD messages as unicast or multicast SD messages to one or more selected SD serving nodes.

### CROSS-REFERENCE TO RELATED APPLICATIONS

This application is a continuation of International Application No. PCT/EP2015/069817, filed on Aug. 31, 2015, the disclosure of which is hereby incorporated by reference in its entirety.

### TECHNICAL FIELD

The present application relates to service or device discovery messages in software-defined networks (SDNs).

### BACKGROUND

Service and device discovery (SD) procedures are used for automatic and dynamic detection of services and devices within a computer network. Usually, SD procedures use specific discovery protocols to advertise or detect available services and devices. When a discovery protocol is unaware of the presence of any particular entity in the network, it may initially start by transmitting broadcast or multicast SD messages to the network. However, broadcast or multicast SD messages may have an adverse effect on the computer network by causing SD-related broadcast flooding.

For example, when using Ethernet and TCP/IP, multicast messages may result in L2 (Layer 2) broadcast messages due to the non-existence of an addressee having the multicast MAC-address to which the Ethernet frames wrapping the IP packets are directed, which may demand considerable network resources since L2 broadcast messages need to be delivered to every network port. For a given network, this may only scale up to some number of devices and network ports and may require L2 segment size limitations. Moreover, although routers or gateways may be used to interconnect separate L2 segments, they may be required to not relay broadcast messages over segment boundaries, thereby making discovery of otherwise useful services and devices over L2 segment boundaries complicated.

### SUMMARY

According to a first aspect of the present disclosure, there is provided a method of redirecting service or device discovery, SD, messages in a software-defined network, SDN, comprising a plurality of network nodes, one or more SD serving nodes and a server. The method comprises instructing one or more network nodes of the plurality of network nodes by the server to redirect received broadcast or multicast SD messages as unicast or multicast SD messages to one or more selected SD serving nodes. “Redirecting” in the present application includes changing a destination address a messages as well as forwarding the message to the new destination.

Accordingly, SD-related broadcast flooding is avoided by redirecting the broadcast or multicast SD messages to (dedicated) SD serving nodes. In this regard, the term “service or device discovery message” as used throughout the description and claims shall be understood in a broad sense and encompasses any message that contains information which relates to advertising of services or devices as well as any message that contains information which relates to searching for services or devices. Moreover, the term “software defined network” as used throughout the description and claims shall be understood in a broad sense and encompasses any network having one or more network nodes that store message forwarding rules and are configured to allow for reprogramming or updating of the message forwarding rules by issuing control messages to the network nodes over a network connection.

Moreover, the term “SD serving node” as used throughout the description and claims shall be understood in a broad sense and encompasses network nodes that store SD-related information, such as information on a provision of services or a presence of devices or a search for services or devices by other network nodes. In particular, the term SD serving node encompasses network nodes which provide the stored information to network nodes requiring said information. Moreover, while broadcast and multicast SD messages may be redirected to all SD service nodes in the network as multicast SD messages, it is also contemplated that a received broadcast or multicast message is redirected to some or only one of the available SD serving nodes, e.g., on basis of an assignment of different SD message types to one or more of the available SD serving nodes.

Moreover, the redirecting of multicast messages (besides broadcast messages) may be particularly advantageous in computer networks which rely on network technologies from the Ethernet family (e.g., Ethernet, switched Ethernet, WiFi) at the link layer and the TCP/IP suites on the layers above. This is because with Ethernet and TCP/IP, multicast messages typically result in L2 broadcast messages which need to be delivered to every network port. In practice, this only scales up to a low number of devices and network ports and may require L2 segment size limitations. However, IP routers (or IP gateways) interconnecting separate L2 segments may be required not to relay broadcast messages over IP subnet boundaries making discoveries of otherwise useful devices and services over the IP subnet boundary complicated.

In a first implementation form of the first aspect, the server instructs each of the one or more network nodes to update its flow table with a set of redirection rules, each flow table defining forwarding rules to be applied to messages arriving at a respective network node.

Hence, redirection needs not be static but can be updated, if necessary or desired. For example, upon insertion of a new SD serving node into the network, redirection rules may be updated to redirect SD messages and in particular SD messages of a particular service type to the new SD serving node. Moreover, a SD serving node disconnected from the network may be deleted from the redirection rules so that messages previously redirected to the SD serving node may be redirected to another SD serving node.

In a second implementation form of the first aspect according to the first implementation form of the first aspect or according to the first aspect, the method further comprises determining, by the server, the one or more network nodes by analyzing a network topology of the SDN and selecting, by the server, at least one of the one or more network nodes, wherein each selected network node forms an endpoint of the SDN, to redirect received broadcast or multicast SD messages as unicast or multicast SD messages to the one or more selected SD serving nodes.

As used throughout the description and claims, the term “endpoint of the SDN” is to be understood as a network node that according to network topology may be connected to a new computing device which may provide or request a service or to a network node of another network, for example, a network node, a switch or a router on a network edge. Moreover, the endpoint may be an SDN controlled switch with at least one interface that is exposed to a non-SDN controlled switch or an SDN controlled switch in a different SDN network. In particular, an endpoint of the SDN may be a switch having a wired connection to a plug in a wall socket to which an Ethernet cable may be connected.

In a third implementation form of the first aspect according to the first or second implementation form of the first aspect or according to the first aspect, the method further comprises receiving a redirected SD message by a SD serving node of the one or more selected SD serving nodes and determining, by the SD serving node, based on a service type of the received SD message, a computing device which provides or requests a service of the service type. The method further comprises sending a unicast response to the SD message, by the SD serving node, to a sender of the SD message, the response indicating the determined computing device, or forwarding the SD message, by the SD serving node, to the determined computing device which then replies directly to the sender of the SD message. The method further comprises storing, by the SD serving node, a look-up table linking service provisions and service requests to computing devices, wherein the look-up table is updated, by the SD serving node, based on received SD messages.

The SD serving node thus either provides a requesting device from which the SD message originates with information on a device which provides (or requests) the desired service or forwards the SD message to a device which provides (or requests) the desired service. Accordingly, the requesting device may learn about other devices providing or requesting a particular service without flooding the network by transmitting broadcast or multicast SD messages to the network.

In a fourth implementation form of the first aspect according to any one of the first to third implementation forms of the first aspect or according to the first aspect, the server comprises the one or more SD serving nodes.

Hence, the server may instruct the one or more network nodes to redirect the SD messages to itself. The server may then directly respond to the SD messages or forward (or dispatch) the received SD messages to a computing device providing or requesting a particular service as indicated in the SD messages, thereby reducing the number of dedicated hardware units involved in the SD procedure.

In a fifth implementation form of the first aspect the method according to any one of the first to third implementation forms of the first aspect or the method according to the first aspect is applied to a network comprising the SDN and multiple computing devices connected to endpoints of the SDN and running service or device discovery protocols, wherein a type of the service or device discovery protocols is one of UPNP, SSDP, zeroconf, SDP or DLNA.

Thus, SD messages of common service or device discovery protocols can be redirected while preserving the functionality of the service or device discovery protocols and avoiding SD message network flooding.

According to a second aspect of the present disclosure, there is provided a server for use in a software-defined network, SDN, the server maintaining a centralized view of message forwarding rules of one or more network nodes and being adapted to instruct the one or more network nodes to update their flow tables, each flow table defining forwarding rules to be applied to messages arriving at a respective network node, to enable redirecting of broadcast or multicast SD messages received by the one or more network nodes as unicast or multicast SD messages to one or more selected SD serving nodes.

Hence, the server which may be, for example, an OpenFlow controller of a network comprising one or more OpenFlow switches may control the one or more OpenFlow switches to update their flow tables to redirect SD messages to the one or more selected SD serving nodes to avoid SD message flooding of the network.

In a first implementation form of the second aspect, the server is adapted to determine the one or more network nodes by being adapted to analyze a topology of the SDN and to select at least one network node forming an endpoint of the SDN to redirect received broadcast or multicast SD messages as unicast or multicast SD messages to the one or more selected SD serving nodes.

Accordingly, the server monitors those network nodes (switches) to which a computing device may be connected and instructs said network nodes to redirect received broadcast or multicast SD messages to the one or more selected SD serving nodes so that broadcast or multicast SD messages are prevented from flooding the network at the first hop.

In a second implementation form of the second aspect according to the first implementation form of the second aspect or according to the second aspect as such, the server is adapted to instruct the one or more network nodes to install new forwarding rules upon learning activation of a new SD suite in the SDN.

In particular, the new forwarding rules may be directed at redirecting service or device discovery or announcement messages of the new SD suite to allow for support of the new SD suite.

According to a third aspect of the present disclosure, there is provided a service or device discovery, SD, serving node for use in a software defined-defined network, SDN, the SD serving node being adapted to receive a SD message, to determine, based on a service type of the received SD message, a computing device which provides or requests a service of the service type. The SD serving node is further adapted to send a unicast response to the SD message to a sender of the SD message as indicated in the SD message, the unicast response indicating the determined computing device and/or to forward the SD message to the determined computing device. The SD serving node is further adapted to store a look-up table linking service provisions and service requests to computing devices and to update the look-up table based on received SD messages.

Thus, the SD serving node either responds to received SD messages by providing the originator of the message with the required information about service provision capabilities or service demands of another computing device or forwards the SD messages to devices which meet the service request or provision specified by the service types of the SD messages. In this regard, the term “service type” is to be understood in a broad sense and encompasses dedicated single services as well as groups of services or even a general inquiry as to which any services are available in the network.

In a first implementation form of the third aspect, the SD serving node is further adapted to cause one or more network nodes to redirect broadcast or multicast SD messages received by the one or more network nodes as unicast SD message to the SD serving node.

Hence, in this implementation form, the SD serving node acts as the afore-mentioned server. In particular, the functionally of the SD serving node and the server may be implemented in software which runs on a particular hardware unit or IP host, in case of which said hardware unit may (depending on circumstances) act as a SD serving node or the aforementioned server which may, for example, provide the functionality of a controller of an OpenFlow network.

According to a fourth aspect of the present disclosure, there is provided a network node for use in a software defined-defined network, SDN, the network node being adapted to receive instruction to redirect received broadcast or multicast SD messages as unicast or multicast SD messages to one or more selected SD serving nodes.

Accordingly, the network node which may be, for example, an OpenFlow switch avoids SD message flooding of the network by reducing the number of recipients in that the original SD message which is a broadcast or multicast message is converted (in terms of reducing the intended recipients) to another message destined to the one or more selected SD serving nodes.

In a first implementation form of the fourth aspect, the network node is adapted to receive the instruction to update its flow table with a set of redirection rules in response to a control message received from a server, wherein the flow table defines forwarding rules to be applied to messages arriving at the network node.

Thus, the network node can be reconfigured on-the-fly, for example, to integrate a new SD serving node or to delete a SD serving node. This reduces maintenance efforts and provides for seamless integration of a SD procedure in existing networks.

In a second implementation form of the fourth aspect according to the first implementation form of the fourth aspect, the network node is adapted to analyze received SD messages and select one or more SD serving nodes for redirection on basis of a result of the analysis and the set of redirection rules.

Hence, SD messages relating to different types of services can be directed to dedicated SD serving nodes to facilitate matching of service requests and service offers (advertisements). In addition, SD messages relating to high priority services may be sent redundantly to several SD serving nodes to increase availability in case of SD serving node failure.

In a third implementation form of the fourth aspect according to the first or second implementation form of the fourth aspect or according to the fourth aspect, the received broadcast or multicast SD messages conform with a service or device discovery protocol of UPNP, SSDP, zeroconf, SDP, Bonjour or DLNA.

Accordingly, the SD procedure is compatible with current SD protocols or suites and may hence be seamlessly integrated with current computing devices.

According to a fifth aspect of the present disclosure, there is provided a network comprising a software defined network, SDN, comprising a server according to the second aspect or the first implementation form of the second aspect and/or one or more SD serving nodes according to the third aspect or the first implementation form of the first aspect and a plurality of network nodes according to the fourth aspect or any one of the first to third implementation form of the fourth aspect and at least two computing devices connected to endpoints of the SDN and running service or device discovery protocols, wherein a type of the service or device discovery protocols is one of UPNP, SSDP, zeroconf, SDP, Bonjour or DLNA.

### BRIEF DESCRIPTION OF THE DRAWINGS

Several examples of the present disclosure will now be described by way of example only, with reference to the accompanying drawings in which:

FIG. 1 is an illustration of an embodiment of a network according to the present disclosure;

FIG. 2 illustrates an activation of a UPnP SD suite in a network with a standalone SD serving node;

FIG. 3 illustrates an exemplary redirection procedure of a UPnP SSDP message announcing a new service or device in a network with a standalone SD serving node;

FIG. 4 illustrates an exemplary redirection procedure of a UPnP SSDP message directed at searching for a service in a network with a standalone SD serving node;

FIG. 5 illustrates an activation of a UPnP SD suite in a network where the server comprises the SD serving node;

FIG. 6 illustrates an exemplary redirection procedure of a UPnP SSDP message announcing a new service or device in a network where the server comprises the SD serving node; and

FIG. 7 illustrates an exemplary redirection procedure of a UPnP SSDP message directed at searching for a service in a network where the server comprises the SD serving node.

### DETAILED DESCRIPTION

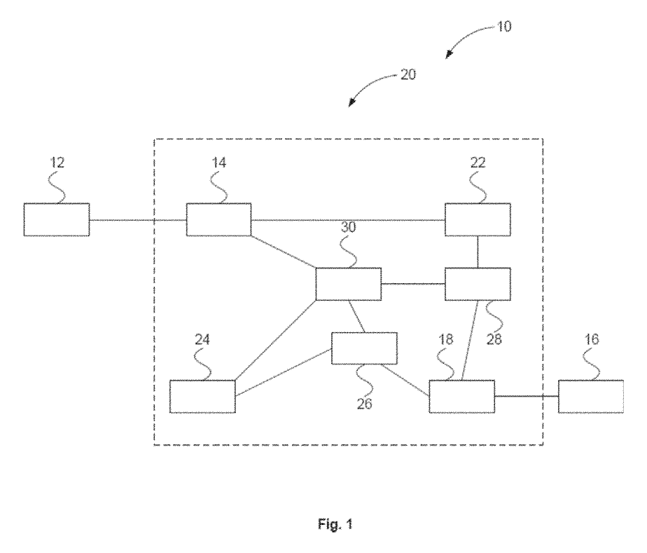

FIG. 1 shows a network 10 comprising a first computing device 12 connected to a first network node (or switch) 14 and a second computing device 16 connected to a second network node (or switch) 18. The first network node (switch) 14 and the second network node (switch) 18 form endpoints of a software defined network (SDN) 20 which is part of the network 10. The SDN 20 further comprises a first SD serving node (or SD server) and a second SD serving node (or SD server) 24 which are connected to the first network node (switch) 14 and to the second network node (switch) 18. Moreover, the SDN 20 comprises further network nodes (switches) 26, 28 and a server 30.

The control plane of the network nodes (switches) 14, 18, 26, 28 is centralized in the server 30 and thus separated from the data plane of the SDN 20. The difference between the data plane traffic and the control plane traffic is in the semantics of the communication purpose. While the data plane traffic may be the exchange of normal, end-user payload, for example, from the first computing device 12 to the second computing device 16, control plane traffic relates to the control exercised by some owner (operator, network administrator, etc.) through the server 30 acting as a SDN controller of the network nodes (switches) 14, 18, 26, 28 in the control plane.

For example, the server 30 may communicate with the network nodes (switches) 14, 18, 26 and 28 through its “southbound APIs” (SBI) to maintain a centralized view of the state of the SDN 20. In particular, the southbound APIs may be implemented by the OpenFlow protocol enabling the server 30 to act as an OpenFlow controller. Through its “northbound APIs” (NBI), the server 30 may enable control applications which may run on the server 30 to manipulate the state of the SDN 20 and execute their logic.

The server 30 may instruct the network nodes (switches) 14, 18, 26, 28 through its southbound APIs to redirect received messages (flows) such as broadcast or multicast SD messages as unicast or multicast SD messages to the SD serving nodes 22 and 24. In this regard, a flow may be described essentially to be a sequence of packets which share a common set of L2-L3-L4 protocol bits (e.g., “all packets destined to the same IP address”). Heretofore, the server 30 may instruct each of the network nodes (switches) 14, 18, 26, 28 through its southbound APIs to update their flow tables with a set of redirection rules.

The flow tables of the network nodes (switches) 14, 18, 26 or 28 may be a collection of all flow treatment rules relevant to the respective one of the network nodes (switches) 14, 18, 26 and 28. Such redirection rules may describe the criteria according to which an SD message is recognized and what actions should be applied to it upon its arrival at one of the network nodes (switches) 14, 18, 26 or 28. Based on the flow tables, the network nodes (switches) 14, 18, 26 and 28 may redirect all L2 broadcast, multicast or any other type of search and notification messages used by service or device discovery suites (i.e., for the announcement and discovery of services and/or devices on the network) to the SD serving nodes 22 and 24.

The server 30 or another network device may implement a Service Registry Service Component (SRSC) to control or make use of the server 30 to deploy SD-suite specific forwarding rules in all respective network nodes (switches) 14, 18, 26 and (e.g., in all switches or only in the “edge” switches). The SRSC may have the knowledge of the respective SD formats and may control or interface with the server 30 to deploy the correspondent OpenFlow forwarding rules as necessary. While these rules may be crafted to correctly match different involved SD protocols, the included actions may define how to treat the matching flows. In this regard, the following exemplary non-limiting strategies for the action may be considered:
redirect a specific flow to the server 30 which may then dispatch it to a respectively responsible SDN SD Control Application (SSCA) implemented (e.g., by software) on the server 30;
redirect a specific flow to corresponding serving nodes 22 and/or 24; or
block a specific flow because it is non-compliant with a local policy, e.g. coming from a port not authorized for service announcements or not authorized for specific SD suite usage or not authorized for specific SD search or announcement at a specific time, etc.

Both, the SSCA and the SD serving nodes 22 and 24 may implement the centralization of the respectively supported SD suites. Hence, all SD-related flows (announcements, notifications and searches) may be redirected by the network nodes (switches) 14, 18, 26 and 28 to the serving nodes 22 and 24 by virtue of being instructed by the server 30. With this information, the server 30 may maintain an updated database of the respectively available services and their locations in the network 10. Using the local SD policy, the SD serving nodes 22 and 24 may match the incoming search requests to the best suitable available service endpoints such as, for example, computing devices 12 and 16, respectively. For example, a search request for a printer coming from the first computing device 12 which may be, according to an example, located on the second floor (as may be determined from computing device's 12 network attachment point) can be answered by either SD serving node 22 or 24 with the information about the printer on the same floor, even though several printers might be available within the same building.

In this regard, it is to be noted that the embodiment described above shall not be limited to the aforementioned strategies which are furthermore not mutually exclusive so that mixed strategies can be used, employing several different strategies per port, host, time, SD type, etc. Therefore, the target of redirection could be one single central element in the whole SDN network 20 (as, for example, the SSCA implemented on the server 30 or one of the SD serving nodes 22 and 24). Moreover, different elements (zero to several SSCAs, zero to several SD serving nodes 22 and 24 or a mix) could be used so as to distribute the SD traffic/computation load, whereas the distribution could be per SD protocol (e.g., SSCA for UPnP and SD serving node 22 for DNS-SD), or by service type (e.g., print SD application and multimedia SD application, etc.). Moreover, SSCA instances could further dispatch the messages by redirecting the received SD messages from the server 30 to the SD serving nodes 22 and/or 24. Furthermore, all these entities are functional and, in a given implementation, the SRSC, SSCA and SD serving nodes 22 and 24 could (but do not need to) reside within one single IP host, e.g., the server 30.

The SRSC may use the server's 30 NBI to register new SD types with the server 30, such as DHCP, UPNP, SSDP, zeroconf, SDP, Bonjour or DLNA. The registration may describe unchangeable characteristics of the respective SD formats, so as to define match fields. It may use the network topology, so as to determine network nodes (switches) 14, 18, 26 and 28 to be used for redirection. Finally, it may also define targets for redirections, according to the used local strategy and the available SD endpoints (e.g., SSCA on the server 30 or SD serving nodes 22 and 24). The registration may trigger the server 30 to distribute the described rules in all network nodes (switches) 14, 18, 26 and 28 having ports that might receive SD-related service or device discovery requests or announcements.

After these registrations, all (broadcast or multicast) packets of every supported SD type may be captured by the first encountered network node (switch) 14, 18, 26 or 28, e.g., at the very first hop and redirected as multicast or unicast messages to the defined targets over the control plane, wherein the target may either be the SSCA on the server 30 or one or both of the SD serving nodes 22 and 24. The target so specified may then receive the incoming flow and treat the received packet(s) following the usual subsequent steps of the corresponding SD procedure as defined by the corresponding SD suite standards (e.g., UPnP, zeroconf, etc.). Since the subsequent steps may rely on multicast or unicast traffic to the SD serving nodes 22 and 24 and since the broadcast traffic is captured and sent as unicast or multicast over the control plane as early as the encounter of the first network node (switch) 14 or 18, all broadcast or multicast SD messages may be removed from the network 10 before the network 10 is flooded by SD messages.

In this regard, it is to be noted that this procedure does not limit the SD scope. In particular, services can be efficiently found by searching computing devices 12 and 16 within the whole network 10 even if they are located in different IP subnetworks, at different ends of the network 10, etc. Indeed, the corresponding SD endpoint (specified as target within the action field, i.e., either the SD server or the SSCA on the server 30) may receive all SD requests of the defined SD type from the whole network 10. This entity may therefore build up a central registry of all available services (from service announcements) within the whole network 10 (i.e., across L2 segments, IP subnetwork boundaries, etc.). In the same manner, this same entity may receive service or device discovery requests from all interested parties, regardless of their location within the subnetworks, segments, etc. This central position enables it to efficiently resolve all service or device discovery requests for the whole network 10, by finding the best suitable/available service candidate for any search request.

Moreover, the SD endpoint defined within the action can apply different policies when matching an interested party (e.g., a client laptop) searching for a service (e.g., a printer) to an available corresponding service end point (e.g., color laser printer at the 2nd floor). As an example, the SD endpoint (e.g., the server 30 or the SD serving nodes 22, 24) could find the closest (topologically or geographically) or semantically best (e.g., redirect MacOSX clients to supported printers, and Windows clients to better suitable printers) service candidates for a given client. As another example, the SD endpoint could perform load balancing by cycling requests through available candidates. It could also match client source addresses to user names and apply authorizations (e.g., by hiding specific services from specific clients).

Typical policies supported through this mechanism could be, but are not limited to, the following:
mobility policies (e.g., automatically find the geographically closest instance of this service type to the requestor position);
load balancing policies (e.g., find the least loaded instance providing the requested service); and/or
security policies (e.g., check if this terminal is entitled to the requested service type like, Internet access, check if the user of the terminal is entitled to print on this specific printer at this time of the day, or force the user to use a specific file server).

Furthermore, it is also possible to only propagate new service announcements to the clients (computing devices 12 and 16) that expressed their interest before. In other words, a search request captured at some point in time t1 could be saved for some period of time Δt, even though no suitable service candidate could be found. If at some later point before t1+Δt an announcement request is received matching the previous search request, this announcement can be directly propagated to the interested client. This would have an additional benefit of speeding up the service or device discovery without clogging the network 10 with announcements that no client is interested in. Using such interest-based filtering, i.e., only propagating requests to available service candidates and only propagating announcements to interested parties may over time emulate an efficient multicast tree at the application layer without requiring any multicast network service.

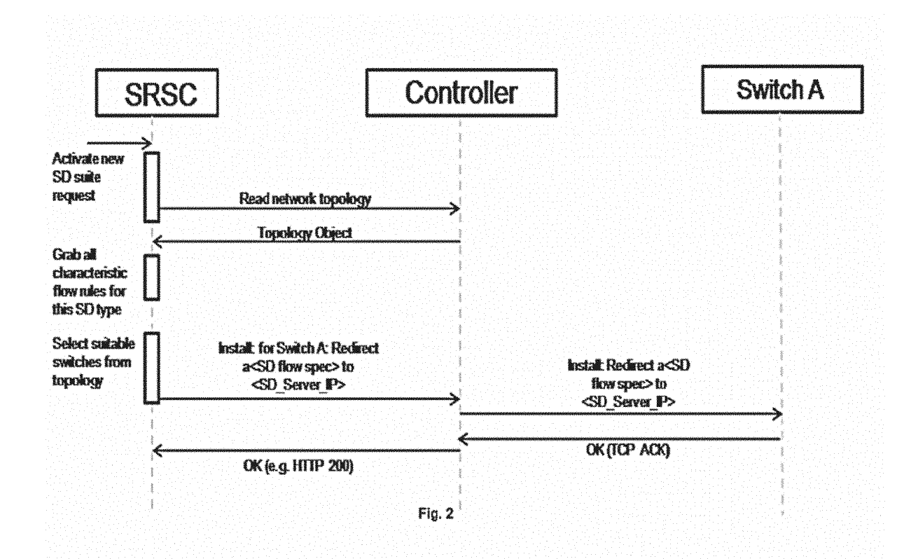

With reference to FIGS. 2-4, non-limiting examples on how SSDP from the UPnP SD suite can be supported in the network is described. In an initial phase, a SD serving node 18 is deployed for support of the UPnP SD suite on an IP host acting as a SD server having the IP address SD_Server_IP and listening on all relevant ports for UPnP. In some initial phase, the SRSC is deployed as a control application on top of the controller implemented on the server 30. The SRSC is configured with the address of the UPnP SD server (SD_Server_IP). The configuration mechanism is omitted in this specification as it is known to the skilled person. In fact, the configuration could be manual, or could itself rely on some autoconfiguration mechanism.

When the UPnP support is activated within the SRSC (over its GUI, as an option, as a consequence of a plugin addition, etc.), the SRSC first uses the controller API (e.g., the server's 30 NBI) in order to select the topologically relevant switches (e.g., all edge switches, network nodes 12 and 16, user equipment, or networked devices such as printers, etc.). Then the SRSC controls the controller API to install in all selected switches the forwarding rules describing the common characteristics of all UPnP SSDP messages (here used with IPv4 as an example), so as to enable matching all SSDP initial requests within the mentioned switches:
Match on:
IPv4 Destination Address: 239.255.255.250
UDP Destination Port: 1900
Action:
Redirect to: <SD_Server_IP>

In this example, the IPv4 destination address and the UDP port are characteristic of UPnP SSDP messages. The SRSC defines an Action field such that all matched packets are redirected to the UPnP SD server (SD_Server_IP). In OpenFlow, this can be done using the optional Set-Field action. In this regard, it is to be noted that replacing the IP destination address will trigger an automatic recalculation of the UDP CRC field as per specification.

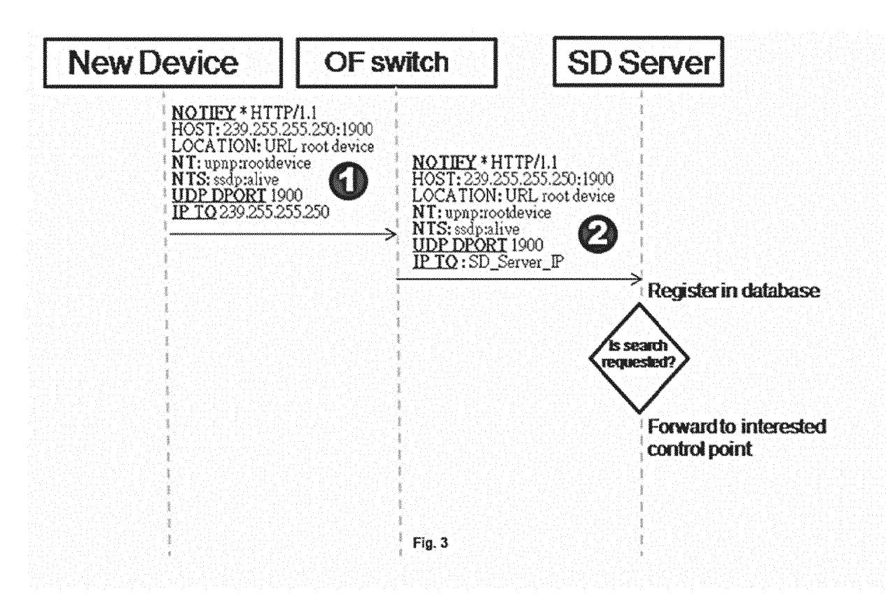

In the next phase, at one moment of time, either some new computing device boots up, or a terminal gets attached to the network 10, or a new service becomes available on a device already attached to the network 10, such as computing device 12 or 16. In any case, the new device/service is announced using the corresponding SSDP mechanism as shown in FIG. 3. The first incoming SSDP packet (marked as (1) in FIG. 3) which may be a multicast packet (having a multicast MAC Address) or a broadcast packet (having a broadcast MAC address) matches a rule preinstalled in the OpenFlow switch. Therefore, the OpenFlow switch acts as instructed per Action of the matched rule, and changes the whole packet, so it is redirected as a unicast packet (having a unicast MAC address) to the SD Server (packet marked as (2) in FIG. 3), which now registers this service in its internal service location registry, i.e., a database that stores per Service type (where the service types are specified in the respective SD suite) the locations (e.g. URLs in UPnP) of all instances of this service. Optionally, the SD Server can now forward this message to all interested end-points (“control points” per UPnP spec language) if previous searches for the same service type were recently captured, speeding up putting proposing and requesting parties together.

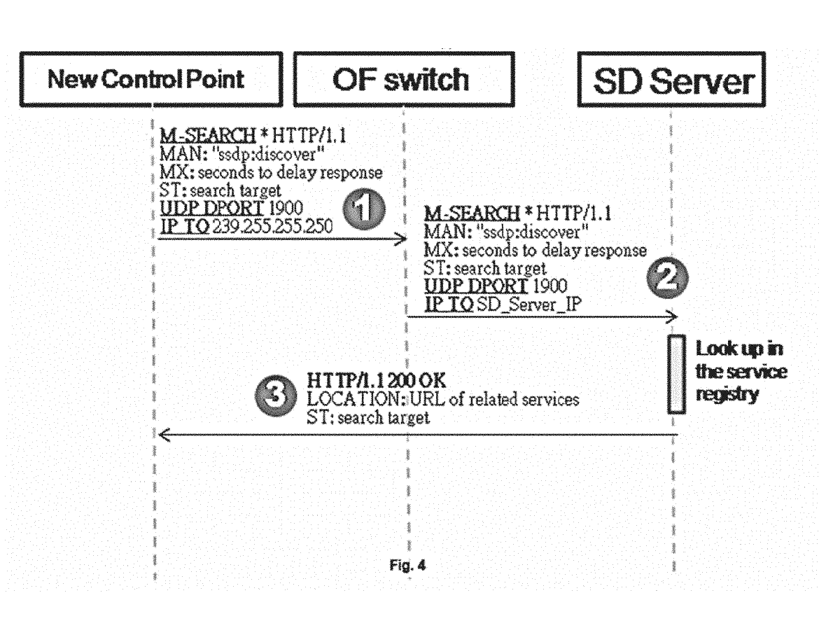

In the next phase, at one moment in time, a new device or a recently started application on an existing device starts searching for a service type previously announced as depicted in FIG. 4 (Remark: since the example is using UPnP, the notion “Control Point” is used, which is a spec compliant notion from UPnP typically referring to an application and/or device that looks for a service to be used—“New Control Point” in FIG. 4). Since the incoming search request (event (1) in FIG. 4) matches the same pre-installed rule, it gets redirected to the SD Server in the same way as described previously (event (2) in FIG. 3). In this example, the SD Server per definition features support for UPnP and SSDP. The SD server uses its integrated SSDP functionality to parse the incoming request and to classify it as a search request. This therefore results in a service location registry lookup, which should yield all registered instances of the requested service type. The SD Server may now apply the local policy and select the best matching service candidate for the requesting entity according to this policy. The SD Server then uses its SSDP functionality to construct a spec-conform reply and to directly send it (as unicast) to the original requestor (event (3) in FIG. 4).

Both, SRSC and SD Server may have a modular design. The basic SRSC and SD Server functionality will be extended by individual SD-dependent plugins, like a plugin for UPnP, a plugin for zeroconf suite, another for DHCP, etc. In this example, the SD Server is well suitable for an implementation as a VNF (virtual network function), such as one conforming to the current ETSI NFV initiative's specifications. Note that this does not affect the internal workings of the SD Server, however SD Server mobility and elasticity (NFV properties) can be easily supported by instructing the SRSC about all new available SD Server instances, i.e., about each new location of the SD Server.

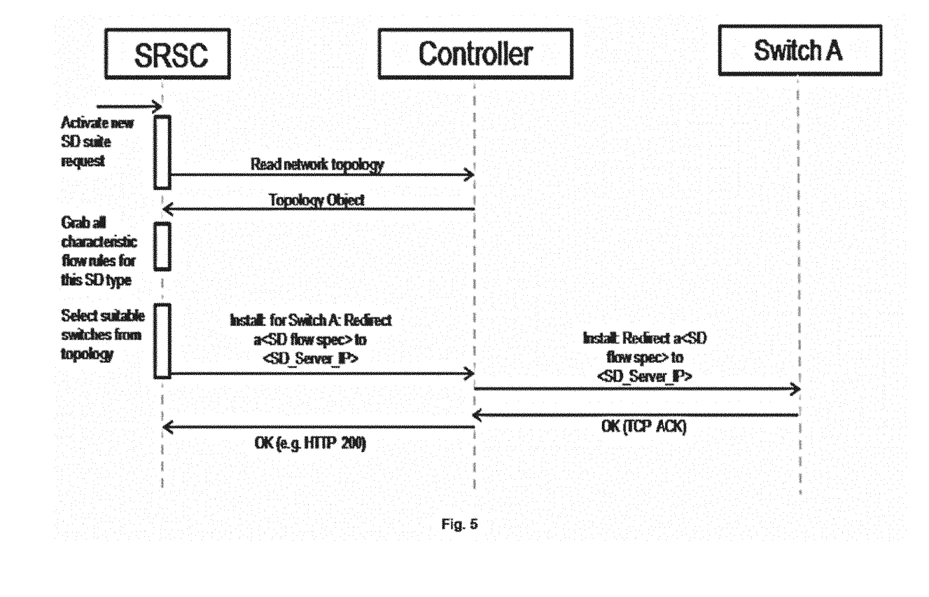

In the following, a further example is described with reference to FIGS. 5-7 which make use of the SRSC and the SSCA, both of which are deployed as SDN control applications on top of the controller implemented on the server 30. In an initial phase, SSCA with the support for the UPnP SD suite is deployed on top of the controller implemented on the server 30, according to the available controller mechanism. For example, the SSCA may use the server's 30 NBI (e.g., JSON and/or the Java API exposed, e.g., in Floodlight). The SSCA has all support for the specific discovery protocol it supports, in this case UPnP. The SSCA may be able to subscribe for all packets that enter the server 30 as “packet_ins”. It may choose to process the ones it is interested in. In this example, the SSCA processes all packets related to the supported SD suite and may ignore the others.

In some initial phase, the SRSC is deployed as a control application on top of the controller, according to the available controller mechanism. The SRSC is configured to use the SSCA on the controller. The configuration mechanism is omitted as it is known to the skilled person. In particular, the configuration mechanism could be manual or could itself rely on the internal controller provisions (e.g., control applications may be able to register with the controller). For example, in a Floodlight implementation of the controller, this may be done via two app registry files, one telling the controller which app to compile and one telling it which ones to load into the execution environment actively.

When the UPnP support is activated within the SRSC (over its GUI, as an option, as a consequence of a plugin addition, etc.), the SRSC first uses the controller API in order to select the topologically relevant switches as shown in FIG. 5 (e.g., all edge switches, switches connected to some terminals, user equipment, networked devices such as printers, etc.). Then the SRSC uses the controller API to install in all selected switches (in FIG. 5, only a switch “A” is shown in order not to obscure the example) the forwarding rules describing the common characteristics of all UPnP SSDP messages (here used with IPv4 as an example) so as to enable matching all SSDP initial requests within the mentioned switches:
Match on:
IPv4 Destination Address: 239.255.255.250
UDP Destination Port: 1900
Action:
Raise Packet_in to CONTROLLER

In this example, the IPv4 destination address and the UDP port are characteristic of UPnP SSDP messages. The SRSC defines an Action field such that all matched packets are captured and redirected to the controller. In OpenFlow, this can be done using the mandatory “Output to CONTROLLER” Action, which results in sending the OFPT_PACKET_IN OpenFlow message. It is to be noted that this step is not obligatory. This is because, OpenFlow switches will normally redirect all unknown flows to the controller using the Output to the CONTROLLER Action if they don't have any specific rules assigned on how to handle the packet (the packet “matches” no rule). While this mechanism may be used, there may be disadvantages:
it is less precise and results in higher controller loads;
it is prone to misunderstandings and errors difficult to discover, especially if other SDN applications on the controller define conflicting rules that match the same flows (e.g., more precise rules for multicast packets could cover some SD suite messages).

For this reason, this example cleanly specifies the exact flows that are needed to handle the controller using the SRSC SD Suite registration, as described above. Moreover, all unknown/undefined flows may be dropped per default rather than redirected to the controller for security reasons.

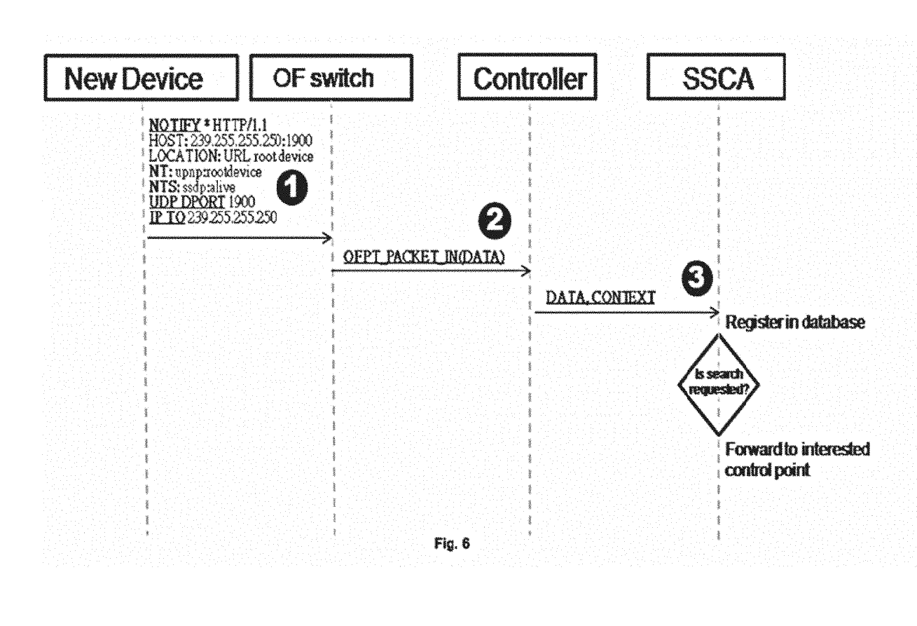

In the next phase, at one moment of time, either some new device boots up, or a terminal gets attached to the network 10, or a new service becomes available on a device already attached to the network 10. In any case, the new device/service are announced using the corresponding SSDP mechanism as per FIG. 6, event (1). The first incoming SSDP packet (marked by (1) in FIG. 6) matches the rule preinstalled in the OpenFlow switch. Therefore, the OpenFlow switch acts as instructed per Action of the matched rule, and redirects the whole packet to the controller (marked as DATA in (2) in FIG. 6).

The whole original packet may be included as payload within the OFPT_PACKET_IN. The SSCA running as a controller App on the server 30 receives this packet_in and recognizes and registers this service in its internal service location registry, i.e., a database that stores per Service type (where the service types are specified in the respective SD suite) the locations (e.g., URLs in UPnP) of all instances of this service. Optionally, the SSCA can now forward this message to all interested end-points (“control points” per UPnP spec language), if previous searches for the same service type were recently captured, speeding up the match of proposing and requesting parties together.

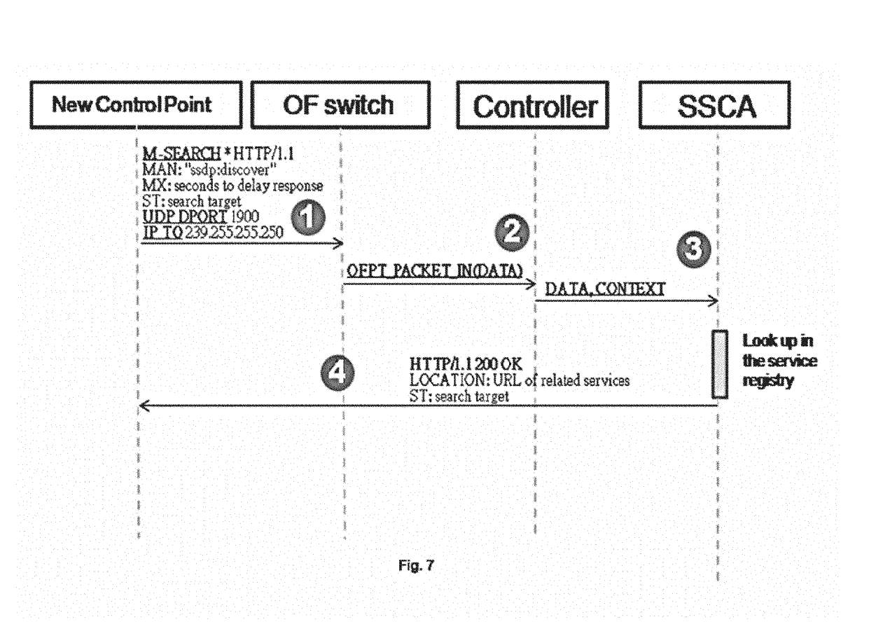

In the next phase, at one moment of time, a new device or a recently started application on an existing device starts searching for a service type previously announced, as depicted in FIG. 7. Since the incoming search request (event (1) in FIG. 7) matches the same pre-installed rule, it gets redirected to the controller in the same way as described previously (event (2) in FIG. 6). Equivalent to the previous phase, the controller extracts the data from the OFPT_PACKET_IN message and hands them over along with the reception context to the control application registered for this event, here SSCA (event (3) in FIG. 7).

In this example, the SSCA features support for UPnP and, therefore, SSDP. The SSCA uses its integrated SSDP functionality to parse the incoming data and to classify it as a search request. This results in a service location registry lookup, which should yield all registered instances of the requested service type. SSCA now can apply the local policy and select the best matching service candidate for the requesting entity according to this policy. The SSCA then uses its SSDP functionality to construct a spec-conform reply and to directly send it (as unicast) to the original requestor (event (4) in FIG. 7).

Again, it is to be noted that SRSC and SSCA are functional entities. An implementation thereof may hence be one single control application that has both SRSC and SSCA functionalities combined.

What is claimed is:

1. A method of redirecting service or device discovery (SD) messages in a software-defined network (SDN) comprising a plurality of network nodes, one or more SD serving nodes and a server, the method comprising:
instructing, by the server, one or more network nodes of the plurality of network nodes to redirect received broadcast or multicast SD messages as unicast or multicast SD messages to one or more selected SD serving nodes.

2. The method of claim 1, further comprising:
instructing, by the server, each of the one or more network nodes to update its flow table with a set of redirection rules, wherein each flow table defines forwarding rules to be applied to messages arriving at a respective network node.

3. The method of claim 1, further comprising:
determining, by the server, the one or more network nodes by analyzing a network topology of the SDN; and
selecting, by the server, at least one of the one or more network nodes, wherein each selected network node forms an endpoint of the SDN, to redirect received broadcast or multicast SD messages as unicast or multicast SD messages to the one or more selected SD serving nodes.

4. The method of claim 1, further comprising:
receiving a redirected SD message by a SD serving node of the one or more selected SD serving nodes;
determining, by the SD serving node, based on a service type of the received SD message, a computing device which provides or requests a service of the service type;
sending, by the SD serving node, a unicast response to the SD message to a sender of the SD message, the unicast response indicating the determined computing device, or forwarding, by the SD serving node, the SD message to the determined computing device for replying directly to the sender of the SD message;
storing, by the SD serving node, a look-up table linking service provisions and service requests to computing devices; and
updating, by the SD serving node, the look-up table based on received SD messages.

5. The method of claim 1, wherein the server comprises the one or more SD serving nodes.

6. The method of claim 1 applied to a network comprising the SDN and multiple computing devices connected to endpoints of the SDN and executing a service or device discovery protocol, wherein a type of the service or device discovery protocol comprises a one of UPNP, SSDP, zeroconf, SDP, Bonjour or DLNA.

7. A server for use in a software-defined network (SDN), the server configured to:
maintain a centralized view of message forwarding rules of one or more network nodes within the SDN;
instruct the one or more network nodes to update their flow tables, each flow table defining forwarding rules to be applied to messages arriving at a respective network node, to enable redirecting of broadcast or multicast SD messages received by the one or more network nodes as unicast or multicast SD messages to one or more selected SD serving nodes.

8. The server of claim 7, wherein the server is further configured to:
determine the one or more network nodes by analyzing a topology of the SDN; and
select at least one network node forming an endpoint of the SDN to redirect received broadcast or multicast SD messages as unicast or multicast SD messages to the one or more selected SD serving nodes.

9. The server of claim 7, wherein the server is configured to:
instruct the one or more network nodes to install new forwarding rules upon learning activation of a new SD suite in the SDN.

10. A service or device discovery (SD) serving node for use in a software defined-defined network, SDN, the SD serving node configured to:
receive a SD message;
determine, based on a service type of the received SD message, a computing device which provides or requests a service of the service type;
send a unicast response to the SD message to a sender of the SD message as indicated in the SD message, the unicast response indicating the determined computing device, and/or forward the SD message to the determined computing device;
store a look-up table linking service provisions and service requests to computing devices; and
update the look-up table based on received SD messages.

11. A network node for use in a software defined-defined network (SDN), the network node configured to:
receive an instruction to redirect received broadcast or multicast SD messages as unicast or multicast SD messages to one or more selected SD serving nodes.

12. The network node of claim 11, wherein the network node is configured to:
receive the instruction to update its flow table with a set of redirection rules in response to a control message received from a server, wherein the flow table defines forwarding rules to be applied to messages arriving at the network node.

13. The network node of claim 12, wherein the network node is configured to:
analyze received SD messages and select one or more SD serving nodes for redirection on basis of a result of the analysis and the set of redirection rules.

14. The network node of claim 11, wherein the received broadcast or multicast SD messages conform with a service or device discovery protocol of UPNP, SSDP, zeroconf, SDP, Bonjour or DLNA.
